(19) United States
(12) Patent Application Publication
(10) Pub. No.: US 2022/0250997 A1
(43) Pub. Date: Aug. 11, 2022

(54) HIGHLY EFFICIENT AND ENVIRONMENT-FRIENDLY REACTIVE EXTRUSION INTEGRATED CONTINUOUS PREPARATION PROCESS FOR A BIODEGRADABLE POLYMERIC MULTI-NUTRIENT NANO SLOW/CONTROLLED-RELEASE FERTILIZER

(71) Applicant: North University of China, Taiyuan (CN)

(72) Inventors: Yaqing Liu, Taiyuan (CN); Yang Xiang, Taiyuan (CN); Guizhe Zhao, Taiyuan (CN)

(73) Assignee: North University of China, Taiyuan (CN)

(21) Appl. No.: 17/564,047

(22) Filed: Dec. 28, 2021

(30) Foreign Application Priority Data
Feb. 6, 2021 (CN) 202110165153.1

(51) Int. Cl. C05C 9/02; C05C 9/00; C05B 7/00; C05G 1/00

(52) U.S. Cl. CPC C05C 9/02; C05G 1/00; C05B 7/00; C05C 9/005

(57) ABSTRACT

The present invention discloses a highly efficient and environment-friendly reactive extrusion integrated continuous preparation process for a biodegradable polymeric multi-nutrient elements nano slow/controlled-release fertilizer and a biodegradable polymeric multi-nutrient elements nano slow/controlled-release fertilizer prepared by the process consisting of urea-formaldehyde macromolecular chains and nano-phosphate. Firstly preparing a methylolurea solution, and then feeding the same into a reactive extrusion integrated machine, adding a phosphate, starting the reaction unit of the reactive extrusion integrated machine to carry out the reaction, and simultaneously starting the vacuumizing devolatilization apparatus to remove moisture from the reaction system; after completing the reaction, starting the extrusion unit of the reactive extrusion integrated machine, extruding to obtain a strip-shaped product, and drying and granulating the same to obtain a finished product. The present invention can achieve forced discharge of the output end of the reaction unit by integrating the extrusion unit and the reaction unit, thereby realizing continuous production of the biodegradable polymeric multi-nutrient nano slow/controlled-release fertilizer. The biodegradable polymeric multi-nutrient nano slow/controlled-release fertilizer prepared by the present invention is firmly bonded between macromolecular chains of urea-formaldehyde through hydrogen bonding, which could impart excellent slow-release performances to nitrogen, phosphorus, potassium and other medium and trace elements; thereby the nutrient use efficiency of the fertilizer is greatly improved.

### TECHNICAL FIELD

The present invention relates to the field of slow-release fertilizers, in particular to a highly efficient and environment-friendly reactive extrusion integrated continuous preparation process for a biodegradable polymeric multi-nutrient nano slow/controlled-release fertilizer.

### BACKGROUND ART

Traditional fertilizers are easy to volatilize, lose or be fixed by soil, thus have low nutrient use efficiency. In particular, the nutrient elements that cannot be absorbed and utilized by plants will be lost to the surrounding environment, which will seriously pollute groundwater resources and cause eutrophication of water bodies in rivers, lakes, and seas. Furthermore, long-term application of these fertilizers can also result in acidification or alkalization of the soil, destruction of the soil structure, hardening of the soil, degradation of the fertility quality, ultimately leading to a reduction in crop yield and crop quality.

In order to improve fertilizer utilization efficiency and strengthen the research of agronomic technology, it is also necessary to upgrade the technology in fertilizer preparation, processing and the like. Currently, the development trend of the fertilizer industry over the world is slow/controlled-release, high efficiency and precision, and environmental friendliness. At the present stage, domestic and overseas research on slow/controlled-release technology of chemical fertilizer mainly focuses on developing the new type of physically coated slow/controlled-release fertilizer. Most of these fertilizers are of a core-shell structure with inorganic compound fertilizers as the core and insoluble materials as the shell, and have the disadvantages of the complex coating process, high cost of coating material and the like, which limits their promotion and application. Especially with the increasing awareness of environmental protection, people gradually realize that the coating materials are difficult to degrade and remain in the soil, which is easy to pollute the soil environment. Polymeric slow-release fertilizers represented by urea-formaldehyde can effectively solve various problems of coated slow/controlled-release fertilizers. However, they have the defects of singleness of nutrients, an excessively long slow-release period and the like, limiting their application range. So urea-formaldehyde fertilizers can only be applied to perennial plants such as those on forest soils, lawns and the like at present, and it is difficult for them to be applied to the short-period crops planted on a large-scale such as maize, rice, wheat, vegetables and the like.

On the other hand, two production methods commonly used at present for urea-formaldehyde polymeric slow/controlled-release fertilizers are the dilute solution method and the concentrated solution method. The dilute solution method comprises the steps of reacting urea with formaldehyde in the form of a dilute solution to generate a urea-formaldehyde suspension and then subjecting the suspension to solid-liquid separation, drying and crushing to obtain the product, and recycling the mother solution. This process is characterized by good product quality. However, it is not easy to realize large-scale mass production due to the complexity and relatively high cost. The concentrated solution method comprises the steps of reacting urea with formaldehyde in a concentrated solution and adding a catalyst (curing agent) directly into the resulting intermediate product without solid-liquid separation to cure into the product. The process of this method is simple and low in production cost, but the resulting high-viscosity urea-formaldehyde is difficult to discharge from a reaction device automatically. Therefore, the method can only stay in the small-scale production stage or even in the laboratory stage. The difficulty in automatic discharging from the reaction device has become one of the main reasons for the failure of industrial scale-up and continuous production of urea-formaldehyde polymerization reaction currently. Therefore, after completion of the polymerization reaction, automatic discharging of high-viscosity urea-formaldehyde becomes the technical key to restrict the continuous production of this reaction.

Reactive extrusion technology has become a new type of polymer moulding technology in recent years. This technology combines two mutually independent processes of material synthesis and processing, and the production process is continuous, various, simple and highly efficient. However, this production technology is still rarely involved in the agricultural field at present. Therefore, using reactive extrusion technology to produce and process polymeric slow/controlled-release fertilizers is expected to solve the ongoing production problem of the urea-formaldehyde polymeric slow/controlled-release fertilizers. Nano-technology has played an essential role in biological science and other fields, and should also have broad application prospects in the agricultural field, owing to the basic characteristics of nano-materials, such as small size effect, surface-interface effect, quantum size effect, quantum tunneling effect and the like, which traditional materials do not possess. Accordingly, the application of nano-technology in agricultural fertilizers to prepare nano-fertilizers is also expected to overcome various defects of conventional slow/controlled-release fertilizers. Currently, internationally developed nano-fertilizers mainly include two major types, i.e., nano-structured fertilizers and nano-material coated or felted slow/controlled-release fertilizers. The nano-structured fertilizers mainly include nano-hydroxyapatite, nano-calcium carbonate, nano-silica and the like. The nano-materials coated or felted slow/controlled-release fertilizers mainly utilize nano-materials, such as nano-inorganic clay, nano-humic acid, and nano-lignin, etc., to adsorb inorganic small molecular fertilizers. However, the preparation of the nano-fertilizers mentioned above needs high-speed shearing dispersion, in-situ growth, self-assembly, solvothermal method and the like. It is not easy to be applied for large-scale industrial production due to its complex processes and expensive facilities. Therefore, the application of nano-technology in the field of slow/controlled-release fertilizers using a simple and environment-friendly process becomes the key to the preparation technology of slow/controlled-release fertilizers.

### SUMMARY OF THE INVENTION

In view of the problems mentioned above, the present invention provides a highly efficient and environment-friendly reactive extrusion integrated continuous preparation process for a biodegradable polymeric multi-nutrient nano slow/controlled-release fertilizer, and a biodegradable polymeric multi-nutrient nano slow/controlled-release fertilizer prepared by the process, which consists of urea-formaldehyde macromolecular chains and nano-phosphate.

The following technical solutions achieve the present invention: a highly efficient and environment-friendly reactive extrusion integrated continuous preparation process for a biodegradable polymeric multi-nutrient nano slow/controlled-release fertilizer, comprising the steps of:

(1) adding a calculated amount of formaldehyde into the reactor of a reactive extrusion integrated machine, then adding a calculated amount of urea, adjusting the pH of the resultant system, and allowing the same to react at a set temperature to obtain a methylolurea solution;

(2) sealing the die opening between the reaction unit and the extrusion unit of the reactive extrusion integrated machine, then injecting the methylolurea solution obtained in step (1) into the horizontal mixer of the reaction unit of the reactive extrusion integrated machine, and then adding a calculated amount of phosphate;

(3) starting the stirring shaft of the horizontal mixer of the reaction unit of the reactive extrusion integrated machine to allow the system to react at a set temperature and a set rotating speed, and simultaneously starting the vacuumizing devolatilization apparatus of the reaction unit of the reactive extrusion integrated machine to remove moisture from the reaction system until the reaction system becomes viscous;

(4) opening the die opening between the reaction unit and the extrusion unit of the reactive extrusion integrated machine and starting the double-screw extruder of the extrusion unit of the reactive extrusion integrated machine so that the viscous product obtained in step (3) is transported into the double-screw extruder through the stirring shaft of the horizontal mixer of the reaction unit of the reactive extrusion integrated machine and extruded through the double-screw extruder to obtain a strip-shaped product; and

(5) oven drying the strip-shaped product obtained in step (4) at a set temperature and granulating the same to obtain the biodegradable polymeric multi-nutrient nano slow/controlled-release fertilizer particles with a good shape.

The highly efficient and environment-friendly reactive extrusion integrated continuous preparation process for a biodegradable polymeric multi-nutrient nano slow/controlled-release fertilizer, wherein a device used is a reactive extrusion integrated machine consisting of a reaction unit and an extrusion unit, the reaction unit and the extrusion unit being connected through a die opening which can be closed and opened; the reaction unit including a horizontal mixer in which the reactions in step (2) and step (3) of the preparation process of claim 1 are carried out, and a vacuumizing devolatilization apparatus; the horizontal mixer including a cylinder, a stirring shaft, and a transverse driving means thereof; the extrusion unit comprises a double-screw extruder.

The preparation process for the biodegradable polymeric multi-nutrient nano slow/controlled-release fertilizer, wherein the molar ratio of urea to formaldehyde in step (1) is (1-2):1.

The preparation process for the biodegradable polymeric multi-nutrient nano slow/controlled-release fertilizer, wherein the system's pH in step (1) is 8-10.

The preparation process for the biodegradable polymeric multi-nutrient nano slow/controlled-release fertilizer, wherein the reaction temperature of formaldehyde and urea in step (1) is 20-100° C.

The preparation process for the biodegradable polymeric multi-nutrient nano slow/controlled-release fertilizer, wherein the phosphate is any one of a composite system of more than one of monopotassium phosphate, ammonium dihydrogen phosphate, ammonium polyphosphate, monocalcium phosphate, phosphate rock powder, bone powder and hydroxyapatite.

The preparation process for the biodegradable polymeric multi-nutrient nano slow/controlled-release fertilizer, wherein the temperature in the horizontal mixer of the reaction unit of the reactive extrusion integrated machine is 30-100° C.

The preparation process for the biodegradable polymeric multi-nutrient nano slow/controlled-release fertilizer, wherein the rotating speed of the stirring shaft in the horizontal mixer of the reaction unit of the reactive extrusion integrated machine is 0-50 r/min and is not 0.

The preparation process for the biodegradable polymeric multi-nutrient nano slow/controlled-release fertilizer, wherein the vacuumizing vacuum degree of the vacuumizing devolatilization apparatus of the reaction unit of the reactive extrusion integrated machine is −0.1-0 MPa and is not 0.

The preparation process for the biodegradable polymeric multi-nutrient nano slow/controlled-release fertilizer, wherein the extrusion rate of the double-screw extruder of the extrusion unit of the reactive extrusion integrated machine is 0-50 r/min and is not 0.

The preparation process for the biodegradable polymeric multi-nutrient nano slow/controlled-release fertilizer, wherein the drying temperature in step (5) is 40-120° C.

The preparation process for the biodegradable polymeric multi-nutrient nano slow/controlled-release fertilizer, wherein the biodegradable polymeric multi-nutrient nano slow/controlled-release fertilizer obtained consists of urea-formaldehyde macromolecular chains and nano-phosphate, and wherein the urea-formaldehyde macromolecular chains are capable of forming strong hydrogen bonding with the nano-phosphate, through which, on one hand, the degree of regular arrangement of the urea-formaldehyde molecular chains can be reduced, thereby reducing the crystallinity of urea-formaldehyde matrix, enhancing the degradation rate of the same, and thus enhancing the element nitrogen release rate and the nitrogen nutrient use efficiency of the same; on the other hand, the grain size of the phosphate is limited to nano-scale by urea-formaldehyde macromolecular chains due to the strong interfacial constraint effect of the urea-formaldehyde matrix when the phosphate is recrystallized during oven drying; furthermore, the hydrogen bonding interaction between the urea-formaldehyde macromolecular chains and the nano-phosphate can also generate strong adsorption on the nano-phosphate molecules, thereby reducing the release rate of nutrient elements such as phosphorus and the like in the phosphate, and thus improving the slow-release performance of the nutrient elements in the phosphate component.

The biodegradable polymeric multi-nutrient nano slow/controlled-release fertilizer, wherein the content of nutrient element nitrogen is from 15 wt % to 36 wt %, the content of nutrient element phosphorus calculated as P₂O₅ is from 0 wt % to 25 wt % and is not 0 wt %, and the content of nutrient element potassium calculated as K₂O is from 0 wt % to 16 wt %.

Depending on different requirements, those skilled in the art can also prepare various biodegradable polymeric multi-nutrient nano slow/controlled-release fertilizers with different contents of nitrogen, phosphorus, potassium, or other medium and trace elements by controlling the addition amounts of urea, formaldehyde and phosphate as the reaction raw materials.

Compared with the existing chemical fertilizers, the present invention has the following advantages:

(1) The highly efficient and environment-friendly reactive extrusion integrated continuous preparation process for a biodegradable polymeric multi-nutrient nano slow/controlled-release fertilizer of the present invention avoids complex processes used in the conventional preparation process for nano-fertilizers, such as high-speed shearing dispersion, in-situ growth, self-assembly and the like. It provides new ideas for developing novel nano-fertilizers with excellent performance and low cost.

(2) The present invention can achieve forced discharge of the output end of the reaction unit by integrating the extrusion unit and the reaction unit, thereby realizing continuous production of the biodegradable polymeric multi-nutrient nano slow/controlled-release fertilizer and solving the problem of failing to achieve continuous production due to the fact that urea-formaldehyde generated in the traditional process cannot be automatically discharged.

(3) The present invention can achieve the reactive extrusion of raw materials with different solid contents by additionally arranging the vacuumizing devolatilization apparatus on the reactive extrusion integrated machine, thereby allowing the nutrient compositions and the content of the final product to be flexible and changeable, and the biodegradable polymeric multi-nutrient nano slow/controlled-release fertilizer that is adapted to different nutrient requirements for crops can be prepared.

(4) The biodegradable polymeric multi-nutrient nano slow/controlled-release fertilizer prepared by the present invention is firmly bonded between macromolecular chains of urea-formaldehyde through hydrogen bonding, which could impart excellent slow-release performances to nutrient elements such as nitrogen, phosphorus, and potassium; thereby significantly improving the use efficiency of the fertilizer. Moreover, the preparation process is simple and efficient, which has a positive promotion effect on realizing the sustainable development of agriculture.

### BRIEF DESCRIPTION OF THE DRAWINGS

In order to illustrate the embodiments of the present invention or the technical solutions in the prior art more clearly, the drawings used in the embodiments of the description of the prior art will be briefly described below. Obviously, the drawings in the following description are only some examples of the present invention, and for those skilled in the art, other drawings can be obtained according to these drawings without any creative work.

FIG. 1 is a flow diagram of the highly efficient and environment-friendly reactive extrusion integrated continuous preparation process for a biodegradable polymeric multi-nutrient nano slow/controlled-release fertilizer of the present invention.

FIG. 2 is a schematic diagram showing the structure of a reactive extrusion integrated the machine in the highly efficient and environment-friendly reactive extrusion integrated continuous preparation process as described in the present invention.

FIG. 3 is a photograph of the biodegradable polymeric multi-nutrient nano slow/controlled-release fertilizer prepared in Example 3. FIG. 3A shows a strip-shaped product obtained by extruding the biodegradable polymeric multi-nutrient nano slow/controlled-release fertilizer through the extrusion unit of the reactive extrusion integrated machine. FIG. 3B shows the biodegradable polymeric multi-nutrient nano slow/controlled-release fertilizer particles obtained an excellent shape after drying and granulation.

FIG. 4 is an infrared spectrum of the biodegradable polymeric multi-nutrient nano slow/controlled-release fertilizer prepared in Example 3.

FIG. 5 is an X-ray photoelectron spectrum of the biodegradable polymeric multi-nutrient nano slow/controlled-release fertilizer prepared in Example 3.

FIG. 6 is a transmission electron micrograph of the biodegradable polymeric multi-nutrient nano slow/controlled-release fertilizer prepared in Example 3.

FIG. 7 is a scanning electron micrograph of nano-phosphate in the biodegradable polymeric multi-nutrient nano slow/controlled-release fertilizer prepared in Example 3.

FIG. 8 is a graph showing the release curve of nutrient element nitrogen of the biodegradable polymeric multi-nutrient nano slow/controlled-release fertilizer prepared in Example 3.

FIG. 9 is a graph showing the release curve of nutrient element phosphorus of the biodegradable polymeric multi-nutrient nano slow/controlled-release fertilizer prepared in Example 3.

FIG. 10 is a graph showing the release curve of nutrient element potassium of the biodegradable polymeric multi-nutrient nano slow/controlled-release fertilizer prepared in Example 3.

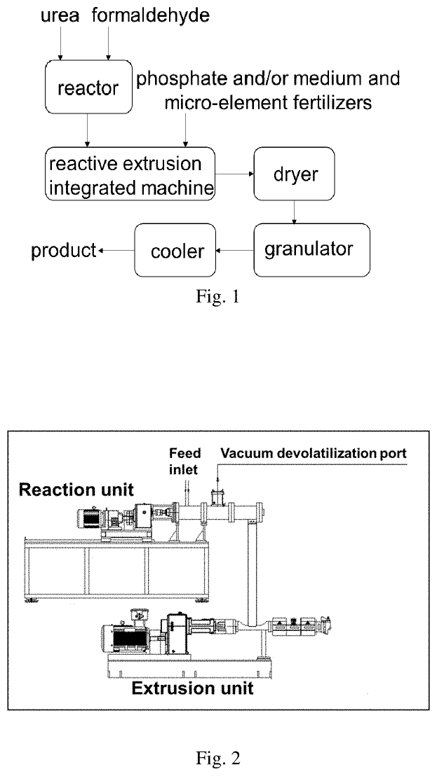

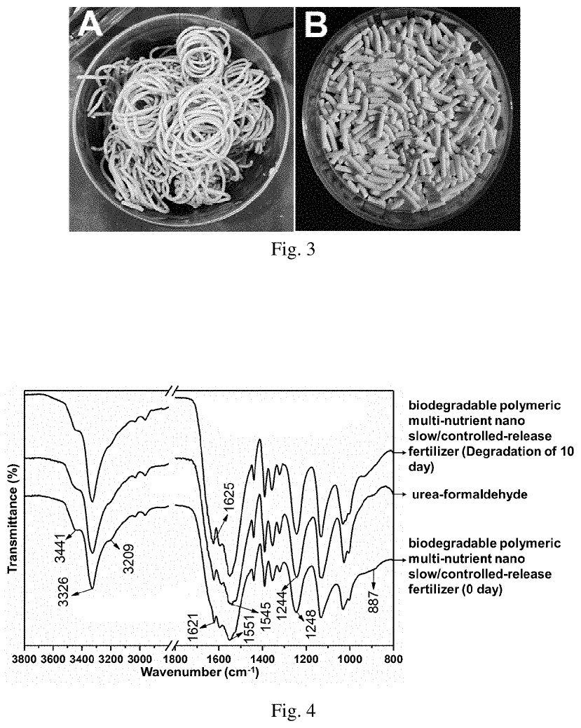

### DETAILED DESCRIPTION OF THE INVENTION

The specific experimental arrangement and test methods in the present invention are as follows:

Pot experiments: tomatoes were planted using rectangular plastic pots with a length of 120 cm by a width of 40 cm by a depth of 28 cm. Each pot was filled with 90 kg of soil passed through a 7 mm screen and air-dried. The identical amounts of N (9 g N/pot), P (9 g P₂O₅/pot) and K (6 g K₂O/pot) were applied by treatment with the biodegradable polymeric multi-nutrient nano slow/controlled-release fertilizer and the physically mixed fertilizer of monopotassium phosphate and urea-formaldehyde, respectively. For the ease of sampling and metering, the materials applied for each treatment were divided into two portions, in which one portion was mixed directly with the soil and the other portion was placed into a plurality of 300 mesh nylon bags (15 cm×10 cm) in equal amounts. Tomato planting and management strictly follows the local agronomic programme. Four sampling time points were set up corresponding to the growth node of the tomatoes, which were the 10^{th} day (seedling period), the 40^{th} day (flowering period), the 70^{th} day (fruiting period) and the 100^{th} day (maturing period), respectively. At each sampling period, three mesh bags were removed from the soil and air-dried. The materials were then manually removed from the mesh bags, carefully separated from the soil, weighed, and further analyzed. An appropriate amount of fertilizer sample was taken and placed into a digestion tube and digested with a concentrated sulfuric acid solution (98 wt %) and a hydrogen peroxide solution (300 g·L⁻¹) until the solution is colourless or clear. The solution was taken for the determination of elements N, P and K. The Kjeldahl method, molybdate colourimetric method and flame photometric method were used to determine the contents of residual nitrogen, phosphorus and potassium in the fertilizer, respectively.

The method for calculating the nitrogen content of the fertilizer is as follows:

$$N ( g \cdot {kg}^{- 1} ) = \frac{( V - {V}_{0} ) \times C ( \frac{1}{2} {H}_{2} {SO}_{4} ) \times 14.0 \times {10}^{- 3}}{m} \times {10}^{3}$$

wherein: V—the volume (mL) of standard acid solution used in the titration of the test solution;

V₀—the volume (mL) of standard acid solution used in the titration of the blank solution;

C—0.01 mol·L⁻¹(½H₂SO₄);

m—the mass of the fertilizer sample (g).

The method for calculating the phosphorus content of the fertilizer is as follows:

$$P ( g \cdot {kg}^{- 1} ) = \frac{ρ \times V \times {V}_{2} \times {10}^{- 3}}{m \times {V}_{2}}$$

wherein: ρ—the mass fraction of phosphorus in the solution to be tested (μg·mL⁻¹);

V—the volume (mL) of the preparation solution of sample;

m—the mass of the fertilizer sample (g);

V₁—the volume (mL) of the filtrate taken;

V₂—the volume (mL) of the chromogenic solution;

The method for calculating the potassium content of the fertilizer is as follows:

$$K ( mg \cdot {kg}^{- 1} ) = ρ \times \frac{V}{m}$$

wherein: ρ—the mass fraction of potassium in the solution to be tested (μg·mL⁻¹);

V—the volume (mL) of the leaching agent added;

m—the mass of the fertilizer sample (g).

### EXAMPLE 1

A highly efficient and environment-friendly reactive extrusion integrated continuous preparation process for a biodegradable polymeric multi-nutrient nano slow/controlled-release fertilizer, comprising the steps of:

(1) adding 831 g of formaldehyde into the reactor of a reactive extrusion integrated machine, then adding 1230 g of urea, adjusting the pH of the resultant system to 8, and allowing the same to react at 60° C. for 2 h to obtain a methylolurea solution;

(2) sealing the die opening between the reaction unit and the extrusion unit of a reactive extrusion integrated machine, then injecting the methylolurea solution obtained in step (1) into the horizontal mixer of the reaction unit of the reactive extrusion integrated machine, and then adding 100 g of monopotassium phosphate;

(3) starting the stirring shaft of the horizontal mixer of the reaction unit of the reactive extrusion integrated machine to allow the system to react at 80° C. and 50 r/min, and simultaneously starting the vacuumizing devolatilization apparatus of the horizontal mixer of the reaction unit of the reactive extrusion integrated machine to remove moisture from the reaction system under a vacuum degree of −0.07 MPa until the reaction system becomes viscous;

(4) opening the die opening between the reaction unit and the extrusion unit of the reactive extrusion integrated machine and starting the double-screw extruder of the extrusion unit of the reactive extrusion integrated machine at an extrusion rate of 10 r/min so that the viscous product obtained in step (3) is transported into the double-screw extruder through the stirring shaft of the horizontal mixer of the reaction unit of the reactive extrusion integrated machine and extruded through the double-screw extruder to obtain a strip-shaped product; and

(5) oven drying the strip-shaped product obtained in step (4) at 100° C. and granulating the same to obtain the biodegradable polymeric multi-nutrient nano slow/controlled-release fertilizer particles with a good shape.

The resulting biodegradable polymeric multi-nutrient nano slow/controlled-release fertilizer has a nitrogen content of 35.0 wt %, a phosphorus content of 3.2 wt % calculated as P₂O₅ and a potassium content of 2.1 wt % calculated as K₂O.

### EXAMPLE 2

A highly efficient and environment-friendly reactive extrusion integrated continuous preparation process for a biodegradable polymeric multi-nutrient nano slow/controlled-release fertilizer, comprising the steps of:

(1) adding 831 g of formaldehyde into the reactor of a reactive extrusion integrated machine, then adding 738g of urea, adjusting the pH of the resultant system to 10, and allowing the same to react at 40° C. for 2 h to obtain a methylolurea solution;

(2) sealing the die opening between the reaction unit and the extrusion unit of the reactive extrusion integrated machine, then injecting the methylolurea solution obtained in step (1) into the horizontal mixer of the reaction unit of the reactive extrusion integrated machine, and then adding 100 g of monocalcium phosphate;

(3) starting the stirring shaft of the horizontal mixer of the reaction unit of the reactive extrusion integrated machine to allow the system to react at 60° C. and 50 r/min, and simultaneously starting the vacuumizing devolatilization apparatus of the horizontal mixer of the reaction unit of the reactive extrusion integrated machine to remove moisture from the reaction system under a vacuum degree of −0.07 MPa until the reaction system becomes viscous;

(4) opening the die opening between the reaction unit and the extrusion unit of the reactive extrusion integrated machine and starting the double-screw extruder of the extrusion unit of the reactive extrusion integrated machine at an extrusion rate of 10 r/min so that the viscous product obtained in step (3) is transported into the double-screw extruder through the stirring shaft of the horizontal mixer of the reaction unit of the reactive extrusion integrated machine and extruded through the double-screw extruder to obtain a strip-shaped product; and

(5) oven drying the strip-shaped product obtained in step (4) at 40° C. and granulating the same to obtain the biodegradable polymeric multi-nutrient nano slow/controlled-release fertilizer particles with a good shape.

The resulting biodegradable polymeric multi-nutrient nano slow/controlled-release fertilizer has a nitrogen content of 29.4 wt %, a phosphorus content of 2.4 wt % calculated as P₂O₅ and a potassium content of 0.0 wt % calculated as K₂O.

### EXAMPLE 3

A highly efficient and environment-friendly reactive extrusion integrated continuous preparation process for a biodegradable polymeric multi-nutrient nano slow/controlled-release fertilizer, comprising the steps of:

(1) adding 831 g of formaldehyde into the reactor of a reactive extrusion integrated machine, then adding 738 g of urea, adjusting the pH of the resultant system to 8, and allowing the same to react at 40° C. for 2 h to obtain a methylolurea solution;

(2) sealing the die opening between the reaction unit and the extrusion unit of the reactive extrusion integrated machine, then injecting the methylolurea solution obtained in step (1) into the horizontal mixer of the reaction unit of the reactive extrusion integrated machine, and then adding 660 g of monopotassium phosphate;

(3) starting the stirring shaft of the horizontal mixer of the reaction unit of the reactive extrusion integrated machine to allow the system to react at 60° C. and 50 r/min, and simultaneously starting the vacuumizing devolatilization apparatus of the horizontal mixer of the reaction unit of the reactive extrusion integrated machine to remove moisture from the reaction system under a vacuum degree of −0.07 MPa until the reaction system becomes viscous;

(4) opening the die opening between the reaction unit and the extrusion unit of the reactive extrusion integrated machine and starting the double-screw extruder of the extrusion unit of the reactive extrusion integrated machine at an extrusion rate of 10 r/min so that the viscous product obtained in step (3) is transported into the double-screw extruder through the stifling shaft of the horizontal mixer of the reaction unit of the reactive extrusion integrated machine and extruded through the double-screw extruder to obtain a strip-shaped product; and

(5) oven drying the strip-shaped product obtained in step (4) at 100° C. and granulating the same to obtain the biodegradable polymeric multi-nutrient nano slow/controlled-release fertilizer particles with a good shape.

The resulting biodegradable polymeric multi-nutrient nano slow/controlled-release fertilizer has a nitrogen content of 21.3 wt %, a phosphorus content of 21.0 wt % calculated as P₂O₅ and a potassium content of 13.9 wt % calculated as K₂O.

In FIG. 4, the absorption peaks of primary amide stretching vibration of urea-formaldehyde molecule are at 3441 cm⁻¹ and 3209 cm⁻¹; the absorption peak of secondary amide stretching vibration of urea-formaldehyde molecule is at 3326 cm⁻¹; the absorption peak of carbonyl stretching vibration (amide I band) of urea-formaldehyde molecule is at 1621 cm⁻¹; the absorption peak of N—H bond in-plane bending vibration (amide II band) is at 1551 cm⁻¹; the absorption peak of N—H bond in-plane bending vibration (amide III band) is at 1248 cm⁻¹; the absorption peak of P—O stretching vibration of nano-monopotassium phosphate is at 887 cm⁻¹. Compared with single urea-formaldehyde fertilizer, it can be found that the peak wavenumbers of amide II band and amide III band of the biodegradable polymeric multi-nutrient nano slow/controlled-release fertilizer blue shift in different degrees, which indicates that the N—H bond bending vibration needs higher energy, i.e., N—H bond forms more hydrogen bonds. This also indicates that strong hydrogen bonding is formed between the urea-formaldehyde molecular chains and the nano-monopotassium phosphate. After the biodegradable polymeric multi-nutrient nano slow/controlled-release fertilizer is placed in a soil environment for degradation for 10 days, the absorption peak of the carbonyl stretching vibration of the urea-formaldehyde molecular chains in the biodegradable polymeric multi-nutrient nano slow/controlled-release fertilizer blue shifts to 1625 cm⁻¹, indicating that the hydrogen bonding effect between the urea-formaldehyde molecular chains and the nano-monopotassium phosphate is gradually weakened along with the loss of the nano-monopotassium phosphate. The above analysis indicates that there is indeed a strong hydrogen bonding between urea-formaldehyde molecular chains and nano-monopotassium phosphate in the biodegradable polymeric multi-nutrient nano slow/controlled-release fertilizer. The infrared spectrum indicates that the product has said structure.

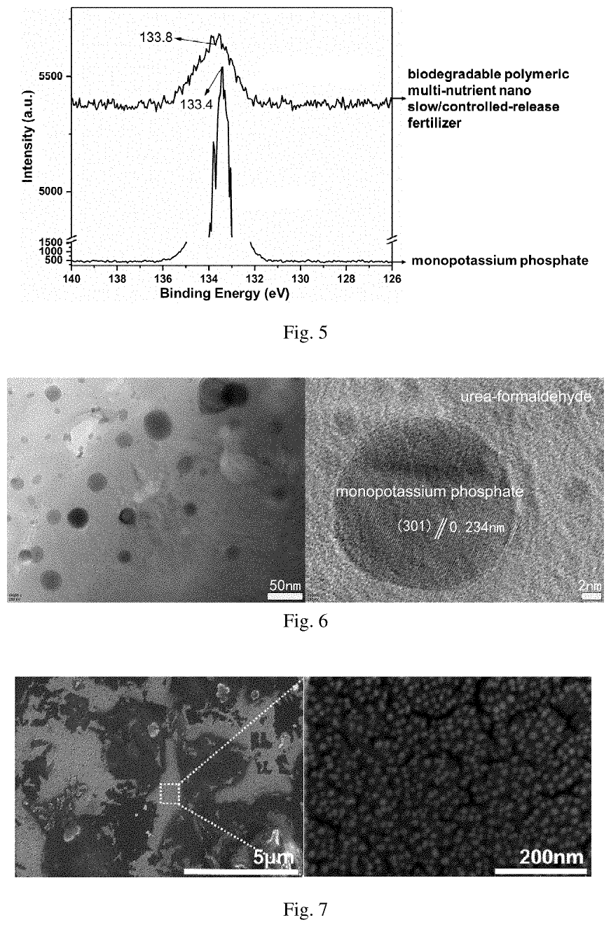

In FIG. 5, the P 2p absorption peak of single monopotassium phosphate is at 133.4 eV. Compared with single monopotassium phosphate, the P 2p absorption peak of nano-monopotassium phosphate in the biodegradable polymeric multi-nutrient nano slow/controlled-release fertilizer blue shifts to 133.8 eV, which indicates that the chemical environment of P in monopotassium phosphate has changed under the influence of urea-formaldehyde molecular chains. This confirms a strong hydrogen bonding between urea-formaldehyde molecular chains and nano-monopotassium phosphate in the biodegradable polymeric multi-nutrient nano slow/controlled-release fertilizer. The X-ray photoelectron spectrum indicates that the product has said structure.

As can be seen from FIG. 6, nano-monopotassium phosphate crystals are randomly embedded in the biodegradable polymeric fertilizer, and the grain size is smaller than 50 nm. The interplanar spacing of monopotassium phosphate was 0.234 nm, corresponding to the crystal plane (301). Nano-monopotassium phosphate crystals tightly adhere to the urea-formaldehyde molecular chains, confirming a robust interfacial force between urea-formaldehyde molecular chains and nano-monopotassium phosphate in the biodegradable polymeric multi-nutrient nano slow/controlled-release fertilizer. The transmission electron micrograph indicates that the product has said structure.

As can be seen from FIG. 7, nano-monopotassium phosphate crystal particles in the biodegradable polymeric multi-nutrient nano slow/controlled-release fertilizer is distributed in a spherical shape with the statistical average particle diameter of 38.27 nm. This illustrates that monopotassium phosphate crystals grow almost isotropically under the hydrogen bonding force of urea-formaldehyde molecular chains, and their grain sizes are limited to nano-scale under the hydrogen bonding force. The scanning electron micrograph indicates that the product has said structure.

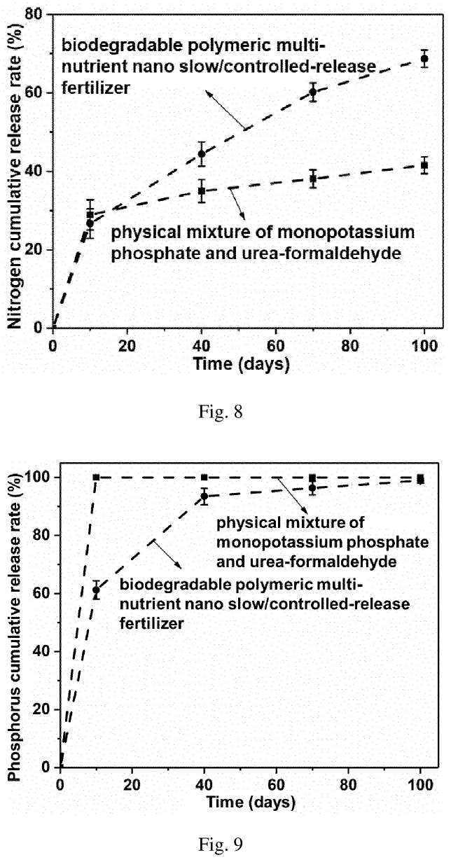

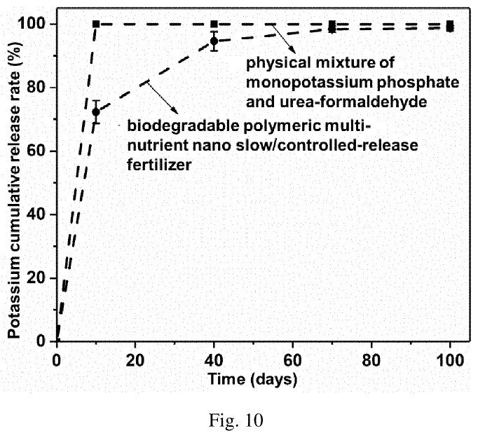

As shown from FIG. 8 to FIG. 10, the release rates of phosphorus and potassium of the biodegradable polymeric multi-nutrient nano slow/controlled-release fertilizer are lower than those of the physically mixed fertilizer of monopotassium phosphate and urea-formaldehyde. The nutrient nitrogen release of the biodegradable polymeric multi-nutrient nano slow/controlled-release fertilizer can be divided into two stages, in which the first 10 days are a rapid release stage, and the release rate reaches 26.7% on Day 10. The nutrient nitrogen is then released substantially at a steady rate, and the release rate reaches 68.7% on Day 100. By contrast, it can be found that the nitrogen release of the physically mixed fertilizer of monopotassium phosphate and urea-formaldehyde has reached equilibrium after Day 10. That is to say, it is challenging to provide nutrient nitrogen to plants after Day 10. It can be seen that the biodegradable polymeric multi-nutrient nano slow/controlled-release fertilizer has a good function of slow/controlled-release of nutrient elements such as nitrogen, phosphorus and potassium, especially controlled-release of nutrient nitrogen.

In the pot experiments, the cumulative release rates of nitrogen of the biodegradable polymeric multi-nutrient nano slow/controlled-release fertilizer on Day 10, Day 40, Day 70 and Day 100 were 26.7%, 44.4%, 60.2% and 68.7%, respectively, which were increased by −7.6%, 27.0%, 58.1% and 65.3% respectively compared with those of the physically mixed fertilizer of monopotassium phosphate and urea-formaldehyde in Comparative Example 1. It indicates that compared with the physically mixed fertilizer of monopotassium phosphate and urea-formaldehyde, the biodegradable polymeric multi-nutrient nano slow/controlled-release fertilizer can more effectively delay the release of nutrient nitrogen at the initial stage and can more effectively and continuously supply nutrient nitrogen for plants at the middle and later stages. For the biodegradable polymeric multi-nutrient nano slow/controlled-release fertilizer, the cumulative release rates of phosphorus on Day 10, Day 40, Day 70 and Day 100 were 61.2%, 93.4%, 96.3% and 98.9%, respectively. The cumulative release rates of potassium on Day 10, Day 40, Day 70 and Day 100 were 72.3%, 94.6%, 98.4% and 98.7%, respectively, while the cumulative release rates of phosphorus and potassium of the physically mixed fertilizer of monopotassium phosphate and urea-formaldehyde have been reached 100% on Day 10. It indicates that the biodegradable polymeric multi-nutrient nano slow/controlled-release fertilizer can more effectively control the release of phosphorus and potassium than the physically mixed fertilizer of monopotassium phosphate and urea-formaldehyde, endowing the phosphorus and potassium with more excellent slow-release performance.

### EXAMPLE 4

A highly efficient and environment-friendly reactive extrusion integrated continuous preparation process for a biodegradable polymeric multi-nutrient nano slow/controlled-release fertilizer, comprising the steps of:

(1) adding 831 g of formaldehyde into the reactor of a reactive extrusion integrated machine, then adding 615 g of urea, adjusting the pH of the resultant system to 8, and allowing the same to react at 40° C. for 2 h to obtain a methylolurea solution;

(2) sealing the die opening between the reaction unit and the extrusion unit of the reactive extrusion integrated machine, then injecting the methylolurea solution obtained in step (1) into the horizontal mixer of the reaction unit of the reactive extrusion integrated machine, and then adding 200 g of monopotassium phosphate;

(3) starting the stirring shaft of the horizontal mixer of the reaction unit of the reactive extrusion integrated machine to allow the system to react at 60° C. and 50 r/min, and simultaneously starting the vacuumizing devolatilization apparatus of the horizontal mixer of the reaction unit of the reactive extrusion integrated machine to remove moisture from the reaction system under a vacuum degree of −0.07 MPa until the reaction system becomes viscous;

(4) opening the die opening between the reaction unit and the extrusion unit of the reactive extrusion integrated machine and starting the double-screw extruder of the extrusion unit of the reactive extrusion integrated machine at an extrusion rate of 10 r/min so that the viscous product obtained in step (3) is transported into the double-screw extruder through the stirring shaft of the horizontal mixer of the reaction unit of the reactive extrusion integrated machine and extruded through the double-screw extruder to obtain a strip-shaped product; and

(5) oven drying the strip-shaped product obtained in step (4) at 120° C. and granulating the same to obtain the biodegradable polymeric multi-nutrient nano slow/controlled-release fertilizer particles with a good shape.

The resulting biodegradable polymeric multi-nutrient nano slow/controlled-release fertilizer has a nitrogen content of 25.5 wt %, a phosphorus content of 9.3 wt % calculated as P₂O₅ and a potassium content of 6.2 wt % calculated as K₂O.

### COMPARATIVE EXAMPLE 1

The preparation process for the physically mixed fertilizer of monopotassium phosphate and urea-formaldehyde comprises the following steps:

(1) adding 831 g of formaldehyde into the reactor of a reactive extrusion integrated machine, then adding 738 g of urea, adjusting the pH of the resultant system to 8, and allowing the same to react at 40° C. for 2 h to obtain a methylolurea solution;

(2) sealing the die opening between the reaction unit and the extrusion unit of the reactive extrusion integrated machine, then injecting the methylolurea solution obtained in step (1) into the horizontal mixer of the reaction unit of the reactive extrusion integrated machine, and then adjusting the pH of the resultant system to 5;

(3) starting the stirring shaft of the horizontal mixer of the reaction unit of the reactive extrusion integrated machine to allow the system to react at 60° C. and 50 r/min, and simultaneously starting the vacuumizing devolatilization apparatus of the horizontal mixer of the reaction unit of the reactive extrusion integrated machine to remove moisture from the reaction system under a vacuum degree of −0.07 MPa until the reaction system becomes viscous;

(4) opening the die opening between the reaction unit and the extrusion unit of the reactive extrusion integrated machine and starting the double-screw extruder of the extrusion unit of the reactive extrusion integrated machine at an extrusion rate of 10 r/min so that the viscous product obtained in step (3) is transported into the double-screw extruder through the stirring shaft of the horizontal mixer of the reaction unit of the reactive extrusion integrated machine and extruded through the double-screw extruder to obtain a strip-shaped product;

(5) oven drying the strip-shaped product obtained in step (4) at 100° C. and granulating the same to obtain the urea-formaldehyde fertilizer particles with a good shape; and

(6) simply and physically mixing the obtained urea-formaldehyde fertilizer particles with 660 g of monopotassium phosphate to obtain the physically mixed fertilizer of monopotassium phosphate and urea-formaldehyde.

The resulting physically mixed fertilizer of monopotassium phosphate and urea-formaldehyde has a nitrogen content of 20.6 wt %, a phosphorus content of 21.6 wt % calculated as P₂O₅ and a potassium content of 13.2 wt % calculated as K₂O. In the pot experiments, the cumulative release rates of nitrogen of this physically mixed fertilizer of monopotassium phosphate and urea-formaldehyde on Day 10, Day 40, Day 70 and Day 100 were 28.9%, 35.0%, 38.1% and 41.5%, respectively, indicating that the release rate of nutrient nitrogen of the physically mixed fertilizer of monopotassium phosphate and urea-formaldehyde was very low after 10 days and it was difficult to provide nutrient nitrogen for plants. The cumulative release rates of phosphorus and potassium of this physically mixed fertilizer of monopotassium phosphate and urea-formaldehyde have reached 100% on Day 10, indicating that nutrients phosphorus and potassium in the physically mixed fertilizer of monopotassium phosphate and urea-formaldehyde essentially have no slow-release effect.

The above description is only the specific embodiments of the present invention. However, the protection scope of the present invention is not limited to those, and any person skilled in the art can easily conceive variations or substitutions within the technical scope disclosed by the present invention. All of the variations and substitutions should be encompassed in the protection scope of the present invention. Therefore, the protection scope of the present invention should be determined by the protection scope of the appended claims.

1. A reactive extrusion integrated continuous preparation process for a biodegradable polymeric multi-nutrient nano slow/controlled-release fertilizer, comprising the steps of:
(1) adding a calculated amount of formaldehyde into the reactor of a reactive extrusion integrated machine, then adding a calculated amount of urea, adjusting the pH of the resultant system, and allowing the same to react at a set temperature to obtain a methylolurea solution;
(2) sealing the die opening between the reaction unit and the extrusion unit of the reactive extrusion integrated machine, then injecting the methylolurea solution obtained in step (1) into the horizontal mixer of the reaction unit of the reactive extrusion integrated machine, and then adding a calculated amount of phosphate;
(3) starting the stirring shaft of the horizontal mixer of the reaction unit of the reactive extrusion integrated machine to allow the system to react at a set temperature and a set rotating speed, and simultaneously starting the vacuumizing devolatilization apparatus of the reaction unit of the reactive extrusion integrated machine to remove moisture from the reaction system until the reaction system becomes viscous;
(4) opening the die opening between the reaction unit and the extrusion unit of the reactive extrusion integrated machine and starting the double-screw extruder of the extrusion unit of the reactive extrusion integrated machine so that the viscous product obtained in step (3) is transported into the double-screw extruder through the stirring shaft of the horizontal mixer of the reaction unit of the reactive extrusion integrated machine and extruded through the double-screw extruder to obtain a strip-shaped product; and
(5) oven drying the strip-shaped product obtained in step (4) at a set temperature and granulating the same to obtain the biodegradable polymeric multi-nutrient elements nano slow/controlled-release fertilizer particles with a good shape.

2. The preparation process according to claim 1, wherein a device used is a reactive extrusion integrated machine consisting of a reaction unit and an extrusion unit, the reaction unit and the extrusion unit being connected through a die opening which can be closed and opened; the reaction unit including a horizontal mixer, in which the reactions in step (2) and step (3) of the preparation process of claim 1 are carried out, and a vacuumizing devolatilization apparatus; the horizontal mixer including a cylinder, a stirring shaft, and a transverse driving means thereof; and the extrusion unit including a double-screw extruder.

3. The preparation process according to claim 1, wherein the molar ratio of urea to formaldehyde in step (1) is (1-2):1.

4. The preparation process according to claim 1, wherein the pH of the system in step (1) is 8-10.

5. The preparation process according to claim 1, wherein the reaction temperature of formaldehyde and urea in step (1) is 20-100° C.

6. The preparation process according to claim 1, wherein the phosphate is any one of a composite system of more than one of monopotassium phosphate, ammonium dihydrogen phosphate, ammonium polyphosphate, monocalcium phosphate, phosphate rock powder, bone powder, and hydroxyapatite.

7. The preparation process according to claim 1, wherein the temperature in the horizontal mixer of the reaction unit of the reactive extrusion integrated machine is 30-100° C.

8. The preparation process according to claim 1, wherein the rotating speed of the stirring shaft in the horizontal mixer of the reaction unit of the reactive extrusion integrated machine is not 0.

9. The preparation process according to claim 1, wherein the vacuumizing vacuum degree of the vacuumizing devolatilization apparatus of the reaction unit of the reactive extrusion integrated machine is not 0.

10. The preparation process according to claim 1, wherein the drying temperature in step (5) is 40-120° C.

11. A biodegradable polymeric multi-nutrient nano slow/controlled-release fertilizer comprising urea-formaldehyde macromolecular chains and nano-phosphate, and wherein the urea-formaldehyde macromolecular chains are capable of forming strong hydrogen bonding with the nano-phosphate, through which the degree of regular arrangement of the urea-formaldehyde molecular chains is reduced, thereby reducing the crystallinity of urea-formaldehyde matrix, enhancing the degradation rate of the same, and thus enhancing the element nitrogen release rate and the nitrogen nutrient use efficiency of the same; wherein the grain size of the phosphate is limited to nano-scale by urea-formaldehyde macromolecular chains due to the interfacial constraint effect of the urea-formaldehyde matrix when the phosphate is recrystallized during oven drying; and wherein the hydrogen bonding interaction between the urea-formaldehyde macromolecular chains and the nano-phosphate generates adsorption on the nano-phosphate molecules, thereby reducing the release rate of nutrient elements in the phosphate, and thus improving the slow controlled-release performance of the nutrient elements in the phosphate component.

12. The fertilizer according to claim 11, wherein the content of nutrient element nitrogen is from 15 wt % to 36 wt %, the content of nutrient element phosphorus calculated as P₂O₅ is from 0 wt % to 25 wt % and is not 0 wt %, and the content of nutrient element potassium calculated as K₂O is from 0 wt % to 16 wt % based on the total weight of the fertilizer.
